(19) United States
(12) Patent Application Publication
(10) Pub. No.: US 2025/0088814 A1
(43) Pub. Date: Mar. 13, 2025

(54) ACOUSTIC OUTPUT DEVICES

(71) Applicant: SHENZHEN SHOKZ CO., LTD., Shenzhen (CN)

(72) Inventors: Wenjun DENG, Shenzhen (CN); Yujia HUANG, Shenzhen (CN); Yongshuai YUAN, Shenzhen (CN); Wenbing ZHOU, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 18/957,926

(22) Filed: Nov. 25, 2024

Related U.S. Application Data
(63) Continuation of application No. PCT/CN2023/072440, filed on Jan. 16, 2023.

(51) Int. Cl. H04R 29/00; H04R 1/10

(52) U.S. Cl. CPC H04R 29/00; H04R 1/10

(57) ABSTRACT

Embodiments of the present disclosure provide an acoustic output device, comprising: an acoustic output unit, a contact detection sensor, and a processor. The acoustic output unit includes a vibration unit and a casing, the casing at least including a contact region which is in contact with the face of a user; the contact detection sensor is located at the contact region; and the processor is configured to determine whether the user wears the acoustic output device based on an electrical signal generated when the contact detection sensor is in contact with the face of the user.

### CROSS-REFERENCE TO RELATED APPLICATIONS

This application is a Continuation of International Application No. PCT/CN2023/072440, filed on Jan. 16, 2023, the entire contents of which are incorporated herein by reference.

### TECHNICAL FIELD

The present disclosure relates to the field of acoustic technology, and in particular, to an acoustic output device.

### BACKGROUND

In the current earphone market, wearing detection sensors are widely used in products like True Wireless Stereo (TWS) earphones. A typical application involves automatically waking up the system when the user is detected to be wearing the earphones and automatically entering a standby mode when the user removes them, which reduces power consumption and extends usage time while also saving users from extra operation steps, thereby significantly enhancing their overall experience. However, due to the significant differences in wearing styles among earphones with different structures, the currently used ear-in detection sensor solutions are difficult to directly transplant into open earphones (i.e., earphones where the casing is near the ear canal but does not block the ear). For example, existing open earphones on the market do not have wearing detection functionality, resulting in a considerable gap in user experience compared to other earphones, and also leading to various issues such as power consumption.

Based on this, it is necessary to provide a new wearing detection scheme.

### SUMMARY

Embodiments of the present disclosure may provide an acoustic output device, comprising an acoustic output unit, a contact detection sensor, and a processor. The acoustic output unit includes a vibration unit and a casing, the casing at least including a contact region which is in contact with the face of a user; the contact detection sensor is located at the contact region; and the processor is configured to determine whether the user wears the acoustic output device based on an electrical signal generated when the contact detection sensor is in contact with the face of the user.

In some embodiments, the contact detection sensor includes an inductive element, a piezoelectric element, and a processing chip. The piezoelectric element is connected with an inner surface of the contact region, the piezoelectric element generates vibration based on a preset voltage, the inductive element is connected in parallel with the piezoelectric element to form a loop, and the processing chip is configured to read out a resonant frequency of the loop.

In some embodiments, the contact detection sensor includes a capacitive element, and the capacitive element is connected in parallel with the piezoelectric element.

In some embodiments, the contact detection sensor includes a first piezoelectric element and a receiving element that are stacked, a side of the first piezoelectric element that is back away from the receiving element is connected with the inner surface of the contact region, the first piezoelectric element generates vibration based on a preset voltage, and a vibration state of the first piezoelectric element changes when the user is in contact with the contact region.

In some embodiments, a resonant frequency of the first piezoelectric element is not less than 20 KHz.

In some embodiments, the receiving element includes an air-conduction microphone or a second piezoelectric element.

In some embodiments, the contact detection sensor further includes a substrate, and the first piezoelectric element and the receiving element are stacked with the substrate.

In some embodiments, the contact detection sensor includes the substrate, a first circuit board, and a resistive thin film layer that are stacked, the substrate is connected with the inner surface of the contact region, the contact detection sensor deforms in response to deformation of the inner surface and converts the deformation into an electrical signal.

In some embodiments, the resistive thin film layer includes at least two sensitive thin film resistors and at least two fixed thin film resistors, and the at least two sensitive thin film resistors are electrically connected with the at least two fixed thin film resistors to form a bridge circuit.

In some embodiments, a plurality of grooves are provided on a surface of the substrate that is connected with the first circuit board, the plurality of grooves including at least two grooves that face the at least two sensitive thin film resistors, respectively.

In some embodiments, the contact detection sensor includes a second circuit board, and a side of the second circuit board is connected with one side of the substrate that is back away from the first circuit board, and another side of the second circuit board is provided with a capacitive electrode.

In some embodiments, the vibration unit is elastically connected with the casing through a vibration transmission sheet, and along a vibration direction of the vibration unit, a spacing between the contact detection sensor and the vibration transmission sheet is greater than 300 um.

In some embodiments, the vibration unit is elastically connected with the casing through the vibration transmission sheet, the vibration transmission sheet includes a hollow region, and a projection of the contact detection sensor along a vibration direction of the vibration unit is located within the hollow region.

In some embodiments, the acoustic output device further comprises a coupling circuit, wherein the contact detection sensor is disposed on an outer surface of the contact region, the coupling circuit is disposed on the inner surface of the contact region, and the coupling circuit is wirelessly coupled with the contact detection sensor.

In some embodiments, the coupling circuit includes a first inductive element, a first capacitive element, and a processing chip, and the contact detection sensor includes a second capacitive element and a second inductive element, the first inductive element is connected in parallel with the first capacitive element to form a first circuit, the second inductive element is connected in parallel with the second capacitive element to form a second circuit, and the processing chip is configured to read out a resonant frequency after the first circuit is coupled with the second circuit.

In some embodiments, the coupling circuit includes a third circuit board, one side of the third circuit board is connected with the inner surface of the contact region, and the first inductive element, the first capacitive element, and the processing chip are located on one side of the third circuit board that is back away from the contact region.

In some embodiments, the second capacitive element and the second inductive element are disposed on the outer surface of the contact region, and the second inductive element is disposed directly opposite to the first inductive element.

In some embodiments, the second capacitive element is a pressure-sensitive capacitor, and a capacitance value of the second capacitive element changes in response to a change in a pressure applied on the second capacitive element.

In some embodiments, the contact detection sensor includes a fourth circuit board, one side of the fourth circuit board is connected with the outer surface of the contact region, and the second capacitive element and the second inductive element are disposed on one side of the fourth circuit board that is back away from the contact region.

In some embodiments, a protective layer is disposed on the outer surface of the contact region, and the protective layer covers the contact detection sensor.

In some embodiments, the processor is configured to issue a control command in response to the user wearing the acoustic output device, and the control command is configured to change an operation state of the acoustic output device.

In some embodiments, the acoustic output device further comprises an ear-hook, wherein one end of the ear-hook is connected with the acoustic output unit, and the ear-hook positions the acoustic output unit near an ear of the user.

In some embodiments, the acoustic output device further comprises a rear-hook. The ear-hook includes a first ear-hook and a second ear-hook, the acoustic output unit includes a first acoustic output unit and a second acoustic output unit, the first ear-hook is connected with the first acoustic output unit and the rear-hook, the second ear-hook is connected with the second acoustic output unit and the rear-hook, the first ear-hook suspends the first acoustic output unit near one ear of the user, the second ear-hook suspends the second acoustic output unit near another ear of the user, and the first ear-hook is connected with the second ear-hook through the rear-hook.

Additional features will be set forth in part in the following description and will become apparent to those skilled in the art by reference to the following and the accompanying drawings or may be appreciated by the generation or operation of examples. Features of the present disclosure may be realized and obtained by practicing or using aspects of the methods, tools, and combinations set forth in the following detailed examples.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, where:

FIG. 1 is a schematic diagram illustrating an exemplary framework of an acoustic output device according to some embodiments of the present disclosure;

FIG. 2 is a schematic diagram illustrating an exemplary structure of an acoustic output device according to some embodiments of the present disclosure;

FIG. 3 is a schematic diagram illustrating an exemplary structure of a contact region of an acoustic output device interacting with a user according to some embodiments of the present disclosure;

FIG. 4 is a schematic diagram illustrating an exemplary circuit of a contact detection sensor of an acoustic output device according to some embodiments of the present disclosure;

FIG. 5 is a schematic diagram illustrating an exemplary frequency response of a contact detection sensor of an acoustic output device according to some embodiments of the present disclosure;

FIG. 6 is a schematic diagram illustrating an exemplary structure of an acoustic output device according to other embodiments of the present disclosure;

FIG. 7 is a schematic diagram illustrating an exemplary structure of an acoustic output device according to some other embodiments of the present disclosure;

FIG. 8 is a schematic diagram illustrating an exemplary structure of a bridge circuit of a contact detection sensor of an acoustic output device according to some embodiments of the present disclosure;

FIG. 9 is a schematic diagram illustrating an exemplary structure of an acoustic output device according to other embodiments of the present disclosure;

FIG. 10 is a schematic diagram illustrating an exemplary structure of an acoustic output device according to some other embodiments of the present disclosure;

FIG. 11 is a schematic diagram illustrating an exemplary structure of an acoustic output device according to some other embodiments of the present disclosure;

FIG. 12 is a schematic diagram illustrating an exemplary structure of an acoustic output device according to some other embodiments of the present disclosure;

FIG. 13 is a schematic diagram illustrating an exemplary structure of an acoustic output device according to some other embodiments of the present disclosure;

FIG. 14 is a schematic diagram illustrating a coupling principle of a contact detection sensor of an acoustic output device according to some embodiments of the present disclosure;

FIG. 15 is a schematic diagram illustrating an exemplary structure of an acoustic output device according to some embodiments of the present disclosure;

FIG. 16 is a schematic diagram illustrating an exemplary structure of an acoustic output device according to some other embodiments of the present disclosure;

FIG. 17A is a schematic diagram illustrating an exemplary acoustic output device in a freely-placed state according to some embodiments of the present disclosure;

FIG. 17B is a schematic diagram illustrating an exemplary acoustic output device in a normal wearing state according to some embodiments of the present disclosure; and

FIG. 17C is a schematic diagram illustrating an exemplary acoustic output device in an abnormal wearing state according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and a person of ordinary skill in the art can apply the present disclosure to other similar scenarios in accordance with these drawings without creative labor. It should be understood that these exemplary embodiments are given only to enable those of ordinary skill in the art to better understand and thus realize the present disclosure, and are not intended to limit the scope of the present disclosure in any way. Unless obviously obtained from the context or the context illustrates otherwise, the same numeral in the drawings refers to the same structure or operation.

As shown in the present disclosure and the claims, unless the context suggests an exception, the words “a”, “an”, “one”, “one kind”, and/or “the” do not refer specifically to the singular, but may also include the plural. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements. The term “based on” is “based at least in part on.”

The term “one embodiment” means “at least one embodiment”. The term “another embodiment” means “at least one other embodiment”.

In the description of the present disclosure, it is to be understood that the terms “front”, “rear”, “ear-hook”, “rear-hook”, etc., indicate an orientation or positional relationship based only on that shown in the accompanying drawings, and are used only to facilitate the description of the present disclosure and simplify the description, and are not intended to indicate or imply that the device or element referred to must have a particular orientation, be constructed and operated in a particular orientation, and therefore are not to be construed as a limitation of the present disclosure.

Additionally, the terms “first” and “second” are used only for descriptive purposes and are not to be construed as indicating or implying relative importance or implicitly specifying the number of technical features indicated. Thus, a feature defined with “first” or “second” may expressly or implicitly include at least one of the features. In the description of the present disclosure, “a plurality of” means at least two, e.g., two, three, or the like, unless explicitly and specifically limited otherwise.

In the present disclosure, unless otherwise expressly specified or limited, the terms “mounted”, “connected”, “connection”, “fixed”, etc., are to be understood in a broad sense, for example, as a fixed connection, a removable connection, or a one-piece connection, a mechanical connection, an electrical connection, a direct connection, an indirect connection through an intermediate medium, a connection within two components, or a connection between two elements or an interactive relationship between the two elements, unless otherwise expressly limited. To one of ordinary skill in the art, the specific meanings of the above terms in the present disclosure may be understood on a case-by-case basis.

Embodiments of the present disclosure provide an acoustic output device that can analyze a current usage state (e.g., a normal wearing state, an abnormal wearing state, or a freely-placed state) of the acoustic output device through a contact detection sensor, and further adjust an operation state of one or more electronic components (e.g., a Bluetooth module, a battery, or the like) of the acoustic output device based on the current usage state of the acoustic output device. In some embodiments, a plurality of sensors (e.g., the same or different types of sensors) are synergized to detect the current usage state of the acoustic output device, thereby enhancing the accuracy of detecting the acoustic output device when being worn. In some embodiments, the contact detection sensor is disposed on an inner surface of a contact region in a casing of the acoustic output device, thereby obviating the need for punching operation of the casing and avoiding disruption of the integrated design of the casing, and thereby improving the sealing performance and waterproof performance of the acoustic output device to a certain extent. In some embodiments, the contact detection sensor is disposed on an outer side of the casing of the acoustic output device, and a signal detected by the contact detection sensor is transmitted to a processing chip on an inner side of the casing by means of wireless coupling, which can improve the sensitivity of the contact detection sensor while ensuring the sealing performance and waterproof performance of the acoustic output device.

The acoustic output device provided by embodiments of the present disclosure is described in detail below in connection with the accompanying drawings.

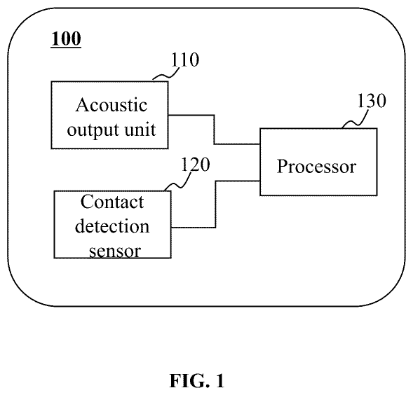

FIG. 1 is a schematic diagram illustrating an exemplary framework of an acoustic output device according to some embodiments of the present disclosure.

Referring to FIG. 1, an acoustic output device 100 may include an acoustic output unit 110, a contact detection sensor 120, and a processor 130. The acoustic output unit 110 and the contact detection sensor 120 are electrically connected to the processor 130.

The acoustic output unit 110 is configured to generate an acoustic signal based on an electrical signal (also referred to as an audio signal). In some embodiments, the acoustic output unit 110 includes a bone-conduction speaker and/or an air-conduction speaker, and accordingly, the acoustic signal is a bone-conduction sound wave and/or an air-conduction sound wave. In some embodiments, the acoustic output unit 110 is the bone-conduction speaker, at which point the acoustic output unit 110 includes a vibration unit and a casing. The casing at least includes a contact region which is in contact with the face of a user. In some embodiments, the contact region is a sidewall of the casing. For example, where the casing is a cylindrical structure, the contact region is a bottom wall of the casing. In some embodiments, the contact region is a localized region of the sidewall of the casing. For example, the sidewall of the casing has a projection that protrudes with respect to a surface of the sidewall, and the projection is the contact region. The vibration unit may receive the electrical signal from the processor 130 and convert the electrical signal into a corresponding vibration signal (also referred to as mechanical vibration). In some embodiments, the vibration signal is transmitted to the skin or bone of the user via the casing, thereby outputting sound to the user in a bone-conduction manner. In some embodiments, the acoustic output unit 110 is the air-conduction speaker. The air-conduction speaker may include a casing, a transducer device, and a vibration diaphragm, with the transducer device and the vibration diaphragm disposed inside the casing, and the transducer device may receive the electrical signal from the processor 130 and drive the vibration diaphragm to vibrate so as to generate the air-conduction sound wave. In some embodiments, the air-conduction speaker is an open structure that is disposed at a location near an ear of the user but does not block an ear canal of the user, and accordingly, the casing at least includes a contact region that is in contact with the face of the user. In some embodiments, the transducer device includes an electromagnetic type (e.g., a moving coil type, a moving iron type, etc.), a piezoelectric type, an inverse piezoelectric type, an electrostatic type, or the like. In some embodiments, the casing includes one or more sound-conduction holes, with the sound-conduction holes facing toward an opening of ear canal of the user when the user wears the acoustic output device 100, and the sound-conduction holes are configured to connect an accommodation cavity inside the casing to the outside and transmit the air-conduction sound wave from an interior of the casing to the outside, thereby transmitting sound to the user in an air-conduction manner.

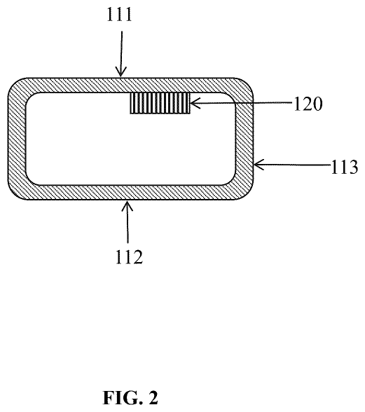

The contact detection sensor 120 may be disposed at the contact region of the casing and configured to generate a corresponding electrical signal based on a contact state between the face of the user and the contact region. The “contact region of the casing” referred to herein may include a region of the casing in contact with the face, which is located at an outer surface of the casing (also referred to as an outer surface of the contact region), or may include an inner side of the casing opposite to a direct contact region, which is located at an inner surface of the casing (also referred to as an inner surface of the contact region), and a projection of the contact region of the casing coincides or nearly coincides with a projection of the direct contact region. In addition, the electrical signal generated by the contact detection sensor 120 is different from the electrical signal (also referred to as the audio signal) based on which the acoustic output unit 110 generates the sound signal, which is clarified here for distinction. In some embodiments, the contact detection sensor 120 includes one or more of an ultrasonic sensor, a resistive sensor (e.g., a resistive pressure sensor), and a capacitive sensor (e.g., a capacitive pressure sensor, and a capacitive skin sensor). In some embodiments, the contact detection sensor 120 is disposed at the inner surface of the contact region of the casing of the acoustic output device. In some embodiments, the contact detection sensor 120 is disposed on the outer surface of the contact region of the casing, and a signal detected by the contact detection sensor is transmitted to the processing chip disposed on the inner side of the casing through wireless coupling. In some embodiments, the contact detection sensor is an optical sensor (e.g., an infrared sensor). More information about the contact detection sensor 120 can be found elsewhere in the present disclosure (e.g., in FIG. 2 to FIG. 14 of the present disclosure and their related descriptions) and is not repeated here.

The processor 130 may be configured to judge whether the user is currently wearing the acoustic output device 100 based on an electrical signal generated by the contact detection sensor 120 when the contact region contacts with the face of the user. In some embodiments, the processor 130 also analyzes a current usage state of the acoustic output device 100 based on a judgment result, and control an operation state of the acoustic output device 100 based on the current usage state. For example, when the acoustic output device 100 is currently in a normal wearing state according to the electrical signal generated by the contact detection sensor 120, the processor 130 wakes up the acoustic output device 100 and control the acoustic output device 100 to automatically connect to the Bluetooth and/or play the music, or when the acoustic output device 100 is currently in an abnormal wearing state or a freely-placed state, the processor 130 controls the acoustic output device 100 to stop playing music or disconnect the Bluetooth connection, and cause the acoustic output device 100 to enter a standby mode after the states have lasted for a period (e.g., 10 seconds, 15 seconds, etc.).

FIG. 2 is a schematic diagram illustrating an exemplary structure of an acoustic output device according to some embodiments of the present disclosure.

Referring to FIG. 2, in some embodiments, a casing 113 of the acoustic output unit 110 includes a contact region which is in contact with the face of user, such as a contact surface 111 or a localized region of the contact surface 111, and an opposite side of the contact surface 111 includes an outer side surface 112 that is back away from the face of the user when the casing is worn. In some embodiments, the casing 113 is a structural body with an interior accommodation cavity, and a vibration unit is provided within the accommodation cavity of the casing 113. In some embodiments, the contact surface 111 and the outer side surface 112 includes a planar surface, a curved surface, or other irregular shape, and when both the contact surface 111 and the outer side surface 112 are planar, the contact surface 111 and the outer side surface 112 are parallel to each other or at an angle of a certain number of degrees (e.g., 0 degree to 45 degrees). In some embodiments, the contact surface 111 has a projection protruding with respect to a surface of the contact surface 111, and the projection is regarded as the contact region which is in contact with the face of the user, and the contact detection sensor 120 is disposed at the projection. In some embodiments, the contact surface 111 and the outer side surface 112 are connected by other connection surfaces, which are planar and/or curved. In some embodiments, a shape of the casing 113 is a cylindrical shape, a rounded platform shape, a rectangular shape, or other three-dimensional structures. In some embodiments, a material of the casing 113 includes plastic, resin, glass, metal, or the like.

In some embodiments, the contact detection sensor 120 is disposed on either an inner surface or an outer surface of the contact surface 111. The inner surface refers to a side of the contact surface 111 that is back away from the human skin in a normal wearing state, and the outer surface refers to a side of the contact surface 111 that is in contact with the human skin in the normal wearing state. Referring to FIG. 2, in some embodiments, the contact detection sensor 120 is provided on the inner surface of the contact surface 111 to facilitate wiring and avoid disruption of the integrated design of the casing 113. It can be understood that by setting the contact detection sensor 120 on the inner surface of the casing 113, it is possible to avoid opening a hole on the casing 113, and to a certain extent, the sealing performance and waterproofing performance of the acoustic output device 100 can be improved.

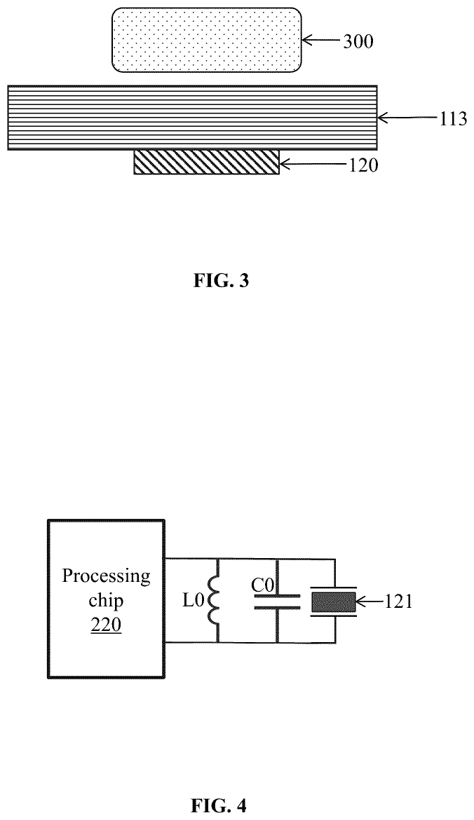

FIG. 3 is a schematic diagram illustrating an exemplary structure of a contact region of an acoustic output device interacting with a user according to some embodiments of the present disclosure.

In some embodiments, the contact detection sensor 120 includes an inductive element, a piezoelectric element, and a processing chip. In some embodiments, the piezoelectric element is connected to an inner surface of a contact region (e.g., the contact surface 111) of the casing 113, with the inductive element being connected in parallel with the piezoelectric element to form a loop. In some embodiments, the piezoelectric element vibrates based on a preset driving signal (e.g., a preset voltage signal or current signal), and the processing chip is configured to read out a resonant frequency of the loop formed by the piezoelectric element and the inductive element. In some embodiments, the piezoelectric element includes a piezoelectric crystal, a piezoelectric semiconductor, or a piezoelectric ceramic. In some embodiments, the piezoelectric element is a regular shape such as a rectangle, a diamond, a circle, an oval, or other irregular shapes, which are not specifically limited in the present disclosure.

Referring to FIG. 3, when a human skin 300 (e.g., the face or a finger of the user) contacts with the casing 113, the additional mass and damping of the human skin 300 may have an effect on the vibration state of the system (e.g., the system consisting of the piezoelectric element and the casing 113), which can change a resonant frequency of the system. In some embodiments, the processor 130 recognizes a current usage state of the acoustic output device 100 based on the resonant frequency read out by the processing chip.

In some embodiments, the processor 130 determines the current usage state of the acoustic output device 100 based on a mapping relationship between the resonant frequency and a usage state. For example, taking a time point as a horizontal coordinate in a two-dimensional coordinate system, with different time points corresponding to different wearing states, taking a resonant frequency as a vertical coordinate in the two-dimensional coordinate system, and taking experimental data as data in the two-dimensional coordinate system, then the experimental data is fitted to obtain a fitting curve, or a functional relationship is obtained by an algorithm, then the usage state of the acoustic output device 100 is determined by a measured resonant frequency. In some embodiments, the processor 130 processes the resonant frequency based on a machine learning model to obtain a current usage state of the acoustic output device 100 corresponding to the resonant frequency. In some embodiments, the machine learning model is trained by a plurality of training samples. The training samples may include resonant frequencies of the acoustic output device 100 in different usage states obtained based on the experimental data and label information corresponding to each of the resonant frequencies. The label information may reflect a current usage state (e.g., a normal wearing state, an abnormal wearing state, a freely-placed state, or the like) of the acoustic output device 100 corresponding to each resonant frequency.

FIG. 4 is a schematic diagram illustrating a circuit of a contact detection sensor of an acoustic output device according to some embodiments of the present disclosure.

Referring to FIG. 4, in some embodiments, the contact detection sensor 120 includes a capacitive element C0, the capacitive element C0 is connected in parallel with a piezoelectric element 121 and an inductive element L0 to form a composite LC resonant loop. The piezoelectric element 121 may play the role of electromechanical coupling, which may couple mechanical vibration between the “casing-piezoelectric element-skin” to the LC electrical resonant loop. When an effective stiffness or an effective mass of a mechanical system changes, the resonant frequency of the LC resonant system may change. In some embodiments, when the human skin 300 contacts with the casing 113 of the acoustic output device 100, effects of the additional mass and damping from the human skin 300 may result in a reduction in the resonant frequency measured by the processing chip 220.

The piezoelectric element 121 may be self-contained with an equivalent shunt electrostatic capacitance Cp, and thus, in some embodiments, the capacitive element C0 in the circuit illustrated in FIG. 4 may be omitted.

In some embodiments, the processing chip 220 first sends an excitation current of a specific frequency to the composite LC resonant loop to cause the circuit to oscillate, and then receive an oscillation signal therefrom and read a resonant frequency of the circuit based on the oscillation signal. In some embodiments, the processing chip 220 obtains the resonant frequency by performing a Fourier transform on the oscillation signal. In some embodiments, by determining a usage state of the acoustic output device 100 based on the resonant frequency, the need to measure an amplitude change may be obviated, thereby more intuitively reflecting a current usage state of the acoustic output device 100 with a higher sensitivity.

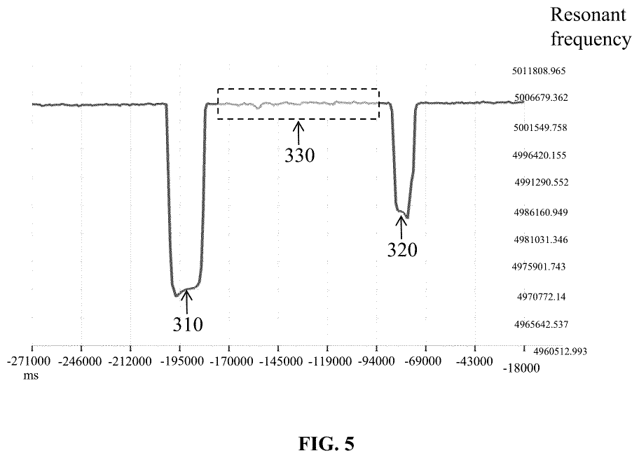

FIG. 5 is a schematic diagram illustrating an exemplary frequency response of a contact detection sensor of an acoustic output device according to some embodiments of the present disclosure.

The skin of different parts (e.g., fingers, the face, etc.) of the human body brings different additional mass and/or damping to the system when contacting with different parts of the casing 113 of the acoustic output device 100, and the system has different resonant frequencies in different states. In some embodiments, the processor 130 determines a current usage state of the acoustic output device 100 based on the resonant frequency.

Exemplarily, referring to FIG. 5, a horizontal coordinate indicates a time (ms) corresponding to signal detection, and a vertical coordinate indicates a resonant frequency (Hz), when a user wears the acoustic output device 100 in a normal wearing state and the user's facial skin is in normal contact with a contact region (e.g., the contact surface 111) of the casing 113 of the acoustic output device 100, the resonant frequency measured by the processing chip 220, as shown at 310, is approximately 4970000 Hz. When the acoustic output device 100 is in an abnormal wearing state and the user's facial skin is in contact with an edge of the contact region (e.g., the contact surface 111) of the casing 113 of the acoustic output device 100, the resonant frequency measured by the processing chip 220, as shown at 320, is approximately 4,984,000 Hz; and when the acoustic output device 100 is in a freely-placed state or when the human skin is in contact with a non-contact region of the casing 113 (e.g., a region other than the contact surface 111), the resonant frequency measured by the processing chip 220, as shown at 330, is approximately 5004000 Hz. It should be noted that FIG. 5 and data shown therein are only intended to illustrate the effect of the contact detection sensor in the acoustic output device provided by the embodiments of the present disclosure, and that resonant frequencies measured under different wearing states are not limited to the specific values mentioned above.

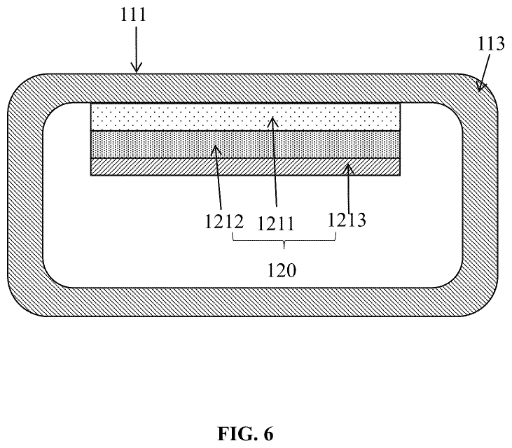

FIG. 6 is a schematic diagram illustrating an exemplary structure of an acoustic output device according to some other embodiments of the present disclosure.

Referring to FIG. 6, in some embodiments, the contact detection sensor 120 includes a first piezoelectric element 1211 and a receiving element 1212 that are stacked, with a side of the first piezoelectric element 1211 that is back away from the receiving element 1212 connected with an inner surface of a contact region. In some embodiments, the first piezoelectric element 1211 and the receiving element 1212 form an ultrasound sensor. The first piezoelectric element 1211 may be configured to generate vibration based on a preset driving signal (e.g., a preset voltage signal or a current signal), and the receiving element 1212 may receive a vibration signal generated by the first piezoelectric element 1211 or an air-conduction sound wave generated after the vibration of the first piezoelectric element 1211 drives the air to vibrate. In some embodiments, the processor 130 determines a current usage state of the acoustic output device 100 based on a signal received by the receiving element 1212.

In some embodiments, the receiving element 1212 includes an air-conduction microphone. Specifically, the first piezoelectric element 1211 generates mechanical vibration under the action of the preset driving signal. When the first piezoelectric element 1211 produces mechanical vibration, it also causes the surrounding air to vibrate, thereby generating an air-conduction sound wave. The air-conduction microphone may receive the air-conduction sound wave produced by vibration of the air driven by the first piezoelectric element 1211 and convert the air-conduction sound wave into a corresponding electrical signal. It should be noted that the first piezoelectric element 1211 may also transmit the vibration to the casing 113, and vibration generated by the casing 113 may also drive the surrounding air of the casing 113 to vibrate, thereby generating the air-conduction sound wave. The air-conduction sound wave herein collected by the air-conduction microphone are from sound waves generated by the air driven by the vibration of the first piezoelectric element 1211 and the casing 113.

In some embodiments, the receiving element 1212 includes a second piezoelectric element. The second piezoelectric element and the first piezoelectric element 1211 are stacked, and when the first piezoelectric element 1211 generates the vibration under the action of the preset driving voltage, since the second piezoelectric element contacts with the first piezoelectric element 1211, the second piezoelectric element may receive vibration generated by the coupling of the first piezoelectric element 1211 with the casing 113, and generate a corresponding electrical signal through the piezoelectric effect.

Referring to FIG. 6, in some embodiments, the contact detection sensor 120 further includes a substrate 1213, with the first piezoelectric element 1211 and the receiving element 1212 being stacked with the substrate 1213. A side of the first piezoelectric element 1211 is connected with an inner surface of the contact surface 111 of the casing 113, and the receiving element 1212 and the substrate 1213 are disposed sequentially on a side of the first piezoelectric element 1211 that is back from the contact surface 111.

It is understood that, as the human skin contacts the casing 113 of the acoustic output device 100, the additional mass and damping brought by the human skin may affect a vibration state of the contact detection sensor 120 and the casing 113, causing the electrical signal received at the receiving element 1212 to change. Therefore, in some embodiments, the processor 130 determines the current usage state of the acoustic output device 100 by processing the electrical signal received by the receiving element 1212. In some embodiments, the processor 130 determines the current usage state of the acoustic output device 100 based on the electrical signal received by the receiving element 1212 and a mapping relationship. The mapping relationship may be obtained by processing experimental data, for example, by measuring electrical signals of the acoustic output device 100 in different wearing states (e.g., a normal wearing state, an abnormal wearing state, a hand contact state, etc.). The experimental data may include time points and electrical signals in wearing states corresponding to different time points, with the time point as a horizontal coordinate in a two-dimensional coordinate system, the different time points corresponding to wearing states, the electrical signal as a vertical coordinate in the two-dimensional coordinate system, and the experimental data as data in the two-dimensional coordinate system, then the experimental data is fitted to obtain a fitting curve, or a functional relationship is obtained by an algorithm. In some embodiments, the processor 130 processes the electrical signal received by the receiving element 1212 based on a machine learning algorithm to determine the current usage state of the acoustic output device 100.

In some embodiments, in order to avoid the mechanical vibration generated by the first piezoelectric element 1211 in the contact detection sensor 120 or the air-conduction sound wave generated by driving the air from interfering with a sound signal outputted by the acoustic output device 100, it is possible to make a resonant frequency of the first piezoelectric element 1211 not less than 20 kHz, i.e., the resonant frequency of the first piezoelectric element 1211 may be in an ultrasonic frequency band, at which time the human ear is unable to receive a sound in this frequency band. In some embodiments, the resonant frequency of the first piezoelectric element 1211 is in a range of 20 kHz to 100 KHz. In some embodiments, the resonant frequency of the first piezoelectric element 1211 is in a range of 25 kHz to 80 KHz.

The first piezoelectric element 1211 may be in a continuous operation state or a periodic operation state. For example, the first piezoelectric element 1211 is in a continuous operation state. As another example, the first piezoelectric element 1211 is periodically operated for a period T, thereby enabling periodic contact detection. For example, the period T is 2 seconds, 5 seconds, 10 seconds, 20 seconds, 30 seconds, 2 minutes, or other durations. It will be appreciated that subjecting the first piezoelectric element 1211 to periodic operation, as compared to a continuous operation state, it may reduce the power consumption of the acoustic output device 100 to a certain extent, thereby extending a battery usage time of the acoustic output device 100.

In some embodiments, the operation state of the first piezoelectric element 1211 is triggered by other sensors, e.g., the acoustic output device 100 further includes an infrared sensor and/or an air pressure sensor based on a flexible cavity. The infrared sensor may be configured to detect a human body, and when the infrared sensor detects the human body, the processor 130 may control the first piezoelectric element 1211 to switch into the operation state from a dormant state, and when the infrared sensor doesn't detect the human body, the first piezoelectric element 1211 may remain in the dormant state. In some embodiments, the infrared sensor is disposed on the contact region (e.g., the contact surface 111) of the casing 113 or other locations where the human body is detected. For example, the acoustic output device 100 also includes a wearable structure (e.g., an ear-hook, a rear-hook, an elastic band, etc.), and the infrared sensor is disposed on a side of the wearable structure which is in contact with or opposite to the user.

In some embodiments, the air pressure sensor based on a flexible cavity at least includes a flexible cavity and an air pressure sensing unit, the air pressure sensing unit is disposed within the closed flexible cavity, and the flexible cavity deforms under the action of an external force, then an air pressure inside the flexible cavity changes, and then the air pressure sensing unit converts the air pressure inside the cavity into a corresponding electrical signal. In some embodiments, the acoustic output device 100 includes a wearable structure (e.g., an ear-hook, a rear-hook, an elastic band, etc.), and the air pressure sensor based on the flexible cavity is disposed at a location where the wearable structure of the acoustic output device 100 is capable of deforming when used by the user. When the user wears the acoustic output device 100, the wearing portion deforms, and the air pressure sensor based on the flexible cavity generates a corresponding electrical signal based on the deformation of the flexible cavity and feeds the electrical signal back to the processor 130. In some embodiments, the processor 130 may control the operation state of the first piezoelectric element 1211 based on the electrical signal fed back by the air pressure sensor based on the flexible cavity.

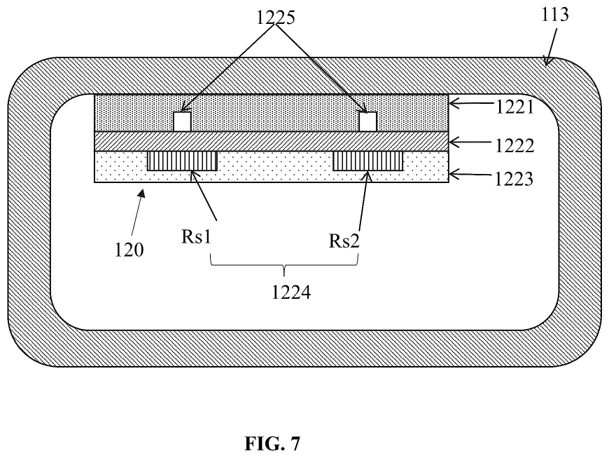

FIG. 7 is a schematic diagram illustrating an exemplary structure of an acoustic output device according to some other embodiments of the present disclosure.

As shown in FIG. 7, in some embodiments, the contact detection sensor 120 includes a substrate 1221, a first circuit board 1222, and a resistive thin film layer 1224 that are stacked, and a side of the substrate 1221 that is back away from the first circuit board 1222 is connected to an inner surface of a contact region (e.g., the contact surface 111) of the casing of the acoustic output device. The substrate 1221, the first circuit board 1222, and the resistive thin film layer 1224 may constitute a resistive pressure sensor, and the contact detection sensor 120 may generate deformation in response to deformation of the contact surface 111 and convert the deformation into a corresponding electrical signal.

In some embodiments, the substrate 1221 is made of a rigid material. In some embodiments, the substrate 1221 includes a metallic material and/or a rigid plastic. Exemplary metal materials may include copper, aluminum, alloys, or the like, and the rigid plastic may include polycarbonate (PC), polystyrene (PS), ABS plastic, or the like. In some embodiments, a side of the substrate 1221 is affixed to the inner surface of the contact surface 111, and the substrate 1221 may deform accordingly in response to a pressure applied to the contact surface 111 (e.g., a contact pressure between the face or fingers of a user and the contact surface 111), and transmit the deformation to the resistive thin film layer 1224.

In some embodiments, the first circuit board 1222 is a flexible printed circuit (FPC), and the first circuit board 1222 is disposed on a side of the substrate 1221 that is back away from the contact surface 111. In some embodiments, the resistive thin film layer 1224 includes at least two sensitive thin film resistors (Rs1 and Rs2 shown in FIG. 7) and at least two fixed thin film resistors (not shown in FIG. 7), i.e., the at least two sensitive thin film resistors and the at least two fixed thin film resistors form the resistive thin film layer 1224. The fixed thin film resistor may have a fixed resistance value, and a resistance value of the sensitive thin film resistor changes in response to its own deformation, specifically, the sensitive thin film resistor may deform in response to the deformation of the substrate 1221, and thus a corresponding resistance value may be obtained. In some embodiments, the at least two sensitive thin film resistors and the at least two fixed thin film resistors are disposed on the side of the first circuit board 1222 that is back from the substrate 1221. In some embodiments, different sensitive thin film resistors and fixed thin film resistors are spaced apart from each other on the side of the first circuit board 1222 that is back from the substrate 1221. In some embodiments, a deformation need of the sensitive thin film resistor is better accommodated by using a flexible printed circuit as the first circuit board 1222.

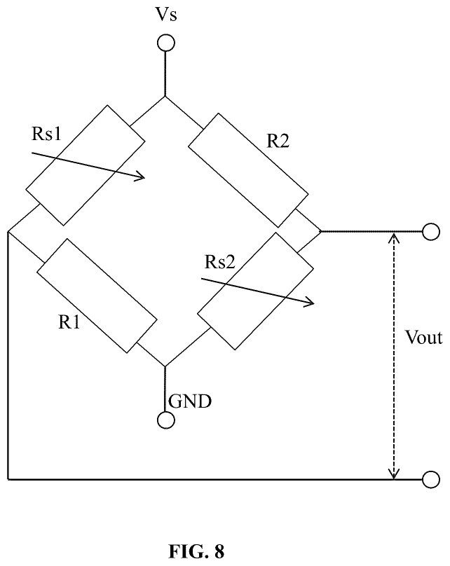

Referring to FIG. 8, in some embodiments, the at least two sensitive thin film resistors includes Rs1 and Rs2, the at least two fixed thin film resistors includes R1 and R2, and the sensitive thin film resistors Rs1 and Rs2 are electrically connected to the two fixed thin film resistors R1 and R2 to form a bridge circuit. As shown in FIG. 8, the bridge circuit may include an input terminal Vs and a ground terminal GND.

Referring to FIG. 7, in some embodiments, the contact detection sensor 120 further includes a first protective layer 1223, the first protective layer 1223 covers a side of the resistive thin film layer 1224 that is back away from the first circuit board 1222 to protect the resistive thin film layer 1224. It is understood that, by providing the first protective layer 1223, the resistive thin film layer 1224 can be prevented from deformation due to be in contact with components other than the substrate 1221, which affects a detection result of the contact detection sensor 120. In some embodiments, a material of the first protective layer 1223 is a rigid material or a flexible material.

In some embodiments, a plurality (e.g., two or more) of grooves 1225 are provided on a surface of the substrate 1221 that is connected to the first circuit board 1222. In some embodiments, the plurality of grooves 1225 include at least two grooves facing each of at least two sensitive thin film resistors, respectively. It will be understood that, for purposes of the present disclosure, the groove 1225 facing the sensitive thin film resistor means that a line connecting centers of the groove 1225 and the sensitive thin film resistor is perpendicular to the first circuit board 1222. In some embodiments, by providing the groove facing the sensitive thin film resistor, it is possible to cause the substrate 1221 to concentrate strain and stress mainly in a region of the groove when deformation occurs and to conduct the strain and stress to the sensitive thin film resistor faced by the groove directly. When the body of a user acts on the contact surface 111, the substrate 1221 may generate a corresponding deformation in response to a pressure on the contact surface 111 and transmit the deformation to the resistive thin film layer 1224 to induce a tensile deformation of the sensitive thin film resistor 1224, which causes a change in a resistance value of the sensitive thin film resistor 1224, resulting in a subsequent change in a readout voltage (Vout). In some embodiments, the processor 130 determines a current usage state of the acoustic output device 100 based on the readout voltage (Vout) and a mapping relationship between the readout voltage (Vout) and a usage state obtained from experimental data. In some embodiments, the processor 130 processes the readout voltage (Vout) based on a machine learning algorithm to determine the current usage state of the acoustic output device 100. In some embodiments, a ratio of a depth of the groove 1225 to a thickness of the substrate 1221 is in a range of ¼ to ¾. In some embodiments, the groove 1225 includes a miniature slit provided on the surface of the substrate 1221 that is connected to the first circuit board 1222.

FIG. 9 is a schematic diagram illustrating an exemplary structure of an acoustic output device according to some other embodiments of the present disclosure.

Referring to FIG. 9, in some embodiments, the contact detection sensor 120 further includes a second circuit board 1226, a side of the second circuit board 1226 is connected to a side of the substrate 1221 that is back away from the first circuit board 1222, and a capacitive electrode 1227 is provided on the other side of the second circuit board 1226. In some embodiments, a plurality of capacitive electrodes 1227 are disposed on the second circuit board 1226, and the plurality of capacitive electrodes 1227 are arranged in an array. In some embodiments, the capacitive electrode 1227 is connected to a contact region of the casing 113, and when the human skin (e.g., the face or fingers of a user) is in contact with the contact region of the casing 113, the human skin, as a conductor, may affect a capacitance value of the capacitive electrode 1227, so that contact detection is realized based on the capacitance value of the capacitive electrode 1227. Through setting the capacitive electrode 1227, a source of pressure applied to the contact region of the casing 113 may be identified, thereby eliminating misrecognition caused by pressure responses resulting from the acoustic output device 100 being placed in a bag, pocket, or other situations where it is compressed or impacted by fabrics, keys, plastics, or other objects.

In some embodiments, by combining the capacitive electrode 1227 with the resistive pressure sensor shown in FIG. 8 to jointly detect the current usage state of the acoustic output device 100, misrecognition caused by collisions or compressions between the acoustic output device 100 and other objects can be avoided when using the resistive pressure sensor alone. Additionally, misrecognition due to external environmental interference from water, sweat, or similar factors can be minimized when using the capacitive electrode 1227 alone. This combination effectively eliminates most interferences and significantly enhances the accuracy of recognizing the usage state of the acoustic output device 100.

In some embodiments, it is determined that the acoustic output device 100 is currently in a normal wearing state when a change in the capacitance value of the capacitive electrode 1227 and a change in the resistance value of the resistive thin film layer 1224 in the resistive pressure sensor reach a threshold value simultaneously, and when only the change in the capacitance value of the capacitive electrode 1227 or only the change in the resistance value of the resistive film layer 1224 reaches the threshold value, the acoustic output device 100 is not in the normal wearing state.

In some embodiments, the capacitive electrode 1227 is combined with the contact detection sensor shown in FIG. 7 for determining the current usage state of the acoustic output device 100. In some embodiments, the capacitive electrode 1227 is regarded as a capacitive sensor, while the contact detection sensor shown in FIG. 7 is regarded a resistive sensor. In some embodiments, a pre-judgment based on the capacitive electrode 1227 is carried out first to exclude a situation in which the acoustic output device 100 is extruded with other objects, and then, the contact detection sensor illustrated in FIG. 7 is configured to determine whether the acoustic output device is currently in the normal wearing state.

In some embodiments, the contact detection sensor shown in FIG. 6 may also be combined with the resistive pressure sensor shown in FIG. 7 to determine the current usage state of the acoustic output device 100. In some embodiments, it is also possible to combine the capacitive electrode 1227 with an infrared sensor to determine the current usage state of the acoustic output device 100.

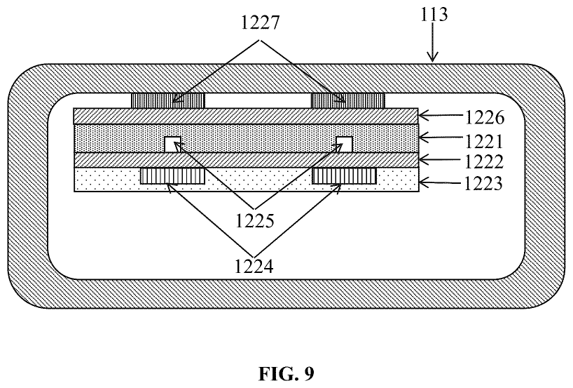

FIG. 10 is a schematic diagram illustrating an exemplary structure of an acoustic output device according to some other embodiments of the present disclosure.

Referring to FIG. 10, when the acoustic output unit is a bone-conduction speaker, an acoustic output unit may include the casing 113, the vibration unit 114, and the contact detection sensor 120. The vibration unit 114 and the contact detection sensor 120 are disposed within an accommodation cavity of the casing 113. The contact detection sensor 120 is disposed on an inner surface of the contact surface 111 of the casing 113 to be contact with the human body. The vibration unit 114 and the casing 113 may be elastically connected via a vibration transmission sheet 115, the vibration transmission sheet 115 may be configured to transmit vibration generated by the vibration unit 114 to the casing 113. In some embodiments, the vibration unit 114 is disposed on a side of the vibration transmission sheet 115 that is back away from the contact detection sensor 120. In some embodiments, when the vibration unit 114 drives the vibration transmission sheet 115 to deform during vibration, the vibration transmission sheet 115 may probably contact with the contact detection sensor 120, which in turn affects a detection result of the contact detection sensor 120 and may also affect a resonant frequency of the vibration unit 114. Therefore, to prevent the vibration unit 114 or the vibration transmission sheet 115 from contacting the contact detection sensor 120 during vibration, a spacing d1 between the contact detection sensor 120 and the vibration transmission sheet 115 may be greater than 300 um along a vibration direction (e.g., a z-z′ direction shown in FIG. 10) of the vibration unit 114. For example, the spacing d1 between the contact detection sensor 120 and the vibration transmission sheet 115 along the vibration direction of the vibration unit 114 is in a range of 300 um to 5000 um. In some embodiments, the spacing d1 between the contact detection sensor 120 and the vibration transmission sheet 115 along the vibration direction of the vibration unit 114 is in a range of 1000 um to 5000 um. In some embodiments, the spacing d1 between the contact detection sensor 120 and the vibration transmission sheet 115 along the vibration direction of the vibration unit 114 is in a range of 1000 um to 4000 um.

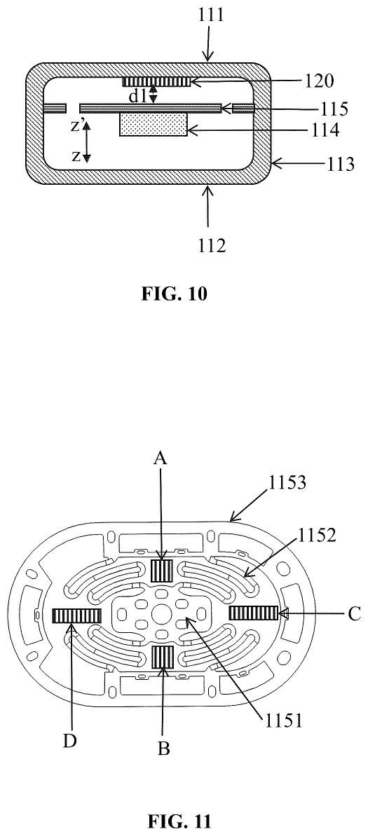

FIG. 11 is a schematic diagram illustrating an exemplary structure of an acoustic output device according to some other embodiments of the present disclosure.

In some embodiments, the vibration transmission sheet 115 may include a center region 1151, an edge region 1153, and a plurality of rods 1152 for connecting the center region 1151 to the edge region 1153. The edge region 1153 may be connected to the casing 113, and the vibration unit 114 may be connected to the center region 1151. Referring to FIG. 11, in some embodiments, the vibration transmission sheet 115 may include a hollow region (e.g., regions A, B, C, D), which may be understood to be a space formed between adjacent rods 1152, an outer edge of the center region 1151, and an inner edge of the edge region 1153. In some embodiments, to avoid the vibration unit 114 or the vibration transmission sheet 115 from being in contact with the contact detection sensor 120 during vibration, the contact detection sensor 120 may be provided within a hollow region of the vibration transmission sheet 115, i.e., a projection of the contact detection sensor 120 along a vibration direction of the vibration unit 114 is within the hollow region of the vibration transmission sheet 115.

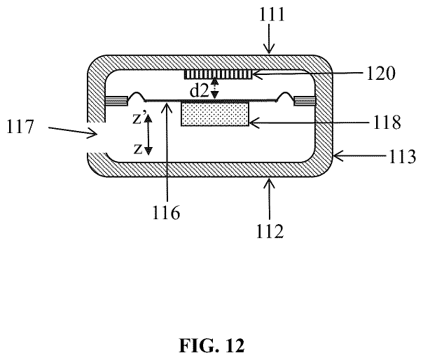

FIG. 12 is a schematic diagram illustrating an exemplary structure of a contact detection sensor of an acoustic output device according to some other embodiments of the present disclosure.

In some embodiments, the acoustic output device 100 includes a vibration diaphragm 116, and the vibration diaphragm 116 is connected to a transducer device 118. The transducer device 118 is configured to drive the vibration diaphragm 116 to vibrate based on an electrical signal, and the vibration diaphragm 116 is configured to drive the air to vibrate to generate an air-conduction sound wave. Referring to FIG. 12, in some embodiments, the casing 113 includes a sound outlet hole 117, and the air driven by the vibration diaphragm 116 is propagated to outside through the sound outlet hole 117. In some embodiments, the sound outlet hole 117 is disposed on a sidewall of the casing 113 that is adjacent to the contact surface 111, and the sound outlet hole 117 is oriented toward an opening of ear canal of a user when the user wears the acoustic output device 100, which facilitates the user to receive the air-conduction sound wave. It should be noted that a structure shown in FIG. 12 is only an exemplary illustration, and in some other embodiments, the sound outlet hole 117 is disposed at other locations of the casing 113. For example, the sound outlet hole 117 is disposed on the outer side surface 112.

In some embodiments, in order to avoid the vibration diaphragm 116 from interfering with a detection result of the contact detection sensor 120 during vibration, a spacing d2 between the contact detection sensor 120 and the vibration diaphragm 116 along a vibration direction of the vibration diaphragm 116 (e.g., a z-z′ direction shown in FIG. 12) is greater than 300 um.

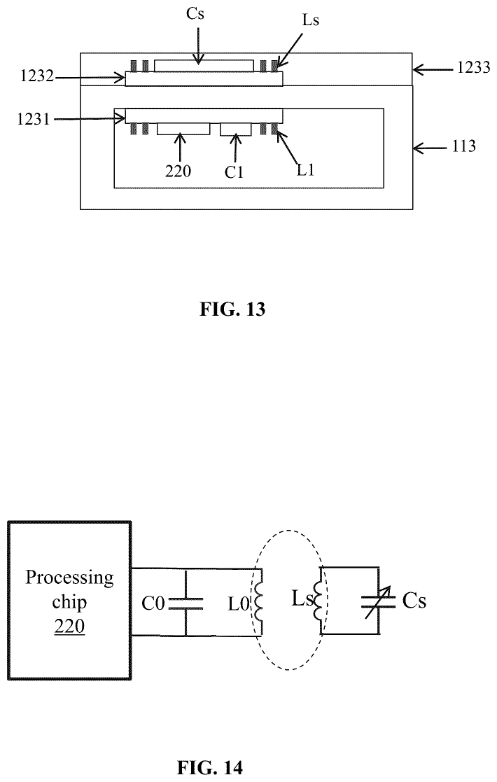

FIG. 13 is a schematic diagram illustrating an exemplary structure of an acoustic output device according to some other embodiments of the present disclosure.

Although setting the contact detection sensor 120 on an inner surface of the casing 113 improves the sealing performance and the waterproof performance of the acoustic output device 100, there is a loss in the sensitivity of the contact detection sensor 120. Therefore, referring to FIG. 13, in some embodiments, for improving the sensitivity of the contact detection sensor 120 while ensuring the sealing performance and the waterproof performance, the contact detection sensor 120 is disposed on an outer surface of a contact region (e.g., the contact surface 111) of the casing 113, and then wirelessly coupled to a coupling circuit disposed on an inner surface of the contact region, thereby transmitting an electrical signal generated by the contact detection sensor 120 to the processing chip 220 located inside the casing 113.

Referring to FIG. 13, in some embodiments, the coupling circuit includes a first inductive element L1, a first capacitive element C1, and a processing chip 220. The contact detection sensor 120 disposed on the outer surface of the contact region of the casing 113 may include a second capacitive element Cs and a second inductive element Ls. The first inductive element L1 is connected in parallel with the first capacitive element C1 to form a first loop, and the second inductive element Ls is connected in parallel with the second capacitive element Cs to form a second loop, and the processing chip 220 may be used to read out a resonant frequency after the first loop is coupled with the second loop.

Referring to FIG. 13, in some embodiments, the coupling circuit includes a third circuit board 1231, a side of the third circuit 1231 is connected with the inner surface of the contact region of the casing 113, e.g., the side of the third circuit 1231 is bonded by glue on the inner surface of the contact region. In some embodiments, the first inductive element L1, the first capacitive element C1, and the processing chip 220 are located on a side of the third circuit board 123 that is back away from the contact region.

In some embodiments, the second capacitive element Cs and the second inductive element Ls are disposed on the outer surface of the contact region of the casing 113. The second inductive element Ls is disposed directly opposite to the first inductive element L1 that is disposed on the inner surface of the contact region of the casing 113, so that it can be ensured that the first inductive element L1 and the second inductive element Ls are better coupled. For example, the second inductive element Ls and the first inductive element L1 are disposed on both an inner side and an outer side of the contact region of the casing 113, respectively, and a line between the second inductive element Ls and the first inductive element L1 is substantially perpendicular to a plane in which the contact region is located.

The second capacitive element Cs may be a pressure-sensitive capacitor, i.e., a capacitance value of the second capacitive element Cs may vary in response to a change in a pressure it is subjected to. In some embodiments, by providing the second capacitive element Cs on the outer surface of the contact region of the casing 113, it may be possible to cause the second capacitive element Cs to better detect a contact pressure between the human skin 300 and the casing 113 of the contact region, thereby increasing the sensitivity of the contact detection sensor 120.

Referring to FIG. 14, the first inductive element L1 may be wirelessly coupled with the second inductive element Ls, and when the capacitance value of the second capacitive element Cs changes according to the contact pressure between the human skin 300 and the contact region of the casing 113, circuit parameters (e.g., capacitance data, voltage data, and/or current data) in the second loop may be transferred to the first loop and cause the circuit parameters in the first loop to subsequently change. In some embodiments, the processing chip 220 may read out the resonant frequency after the first loop is coupled with the second loop based on a change in the circuit parameters.

In some embodiments, the resonant frequency of the first loop is expressed as:

$$ω 1 = \sqrt{\frac{1}{L 1 C 1}} , \qquad ( 1 )$$

the resonant frequency of the second loop is expressed as:

$$ω 2 = \sqrt{\frac{1}{L s C s}} , \qquad ( 2 )$$

and

the resonant frequency after the first loop is coupled with the second loop is expressed as:

$$ω \pm = \frac{( ω {1}^{2} + ω {2}^{2} ) \pm \sqrt{( ω {1}^{2} + ω {2}^{2} ) - 4 ( 1 - {k}^{2} ) ω {1}^{2} ω {2}^{2}}}{2 ( 1 - k )} \qquad ( 3 )$$

where, L1 denotes an inductance value of the first inductive element, Ls denotes an
inductance value of the second inductive element, C1 denotes a capacitance value of the first capacitive element, Cs denotes a capacitance value of the second capacitive element, and k denotes a coupling coefficient between L1 and Ls.

Continuing to refer to FIG. 13, in some embodiments, the contact detection sensor 120 may include a fourth circuit board 1232, a side of the fourth circuit board 1232 is connected to the outer surface of the contact region of the casing 113, and the second capacitive element Cs and the second inductive element Ls may be disposed on a side of the fourth circuit board 1232 that is back away from the contact region. When the human skin 300 is in contact with the contact region of the casing 113, a capacitance value of the second capacitive element Cs may change accordingly in response to the contact pressure between the human skin 300 and the contact region of the casing 113.

Similar to the first circuit board 1222 and the second circuit board 1226, in some embodiments, the third circuit board 1231 and the fourth circuit board 1232 may also include a flexible printed circuit (FPC). In some embodiments, the wireless coupling may include photoelectric coupling. In some embodiments, at least a portion of the contact region of the casing 113 is made of a transparent material (e.g., glass or transparent plastic). The contact detection sensor 120 disposed on the outer surface of the contact region of the casing 113 may include a light-emitting diode, which may be disposed on a transparent portion of the contact region. The coupling circuit provided on the inner surface of the contact region of the casing 113 may include a photosensitive element, the photosensitive element is disposed on the transparent portion of the contact region, and a signal detected by the contact detection sensor 120 may be transmitted to the coupling circuit disposed on the inner surface of the contact region of the casing 113 through a coupling relationship between the light-emitting diode and the photosensitive element. In some embodiments, power supplies are disposed on the inner surface and the outer surface of the contact region for powering the light-emitting diode and the photosensitive element, respectively.

Referring to FIG. 13, in some embodiments, the outer surface of the contact region of the casing 113 is provided with a second protective layer 1233, and the second protective layer 1233 covers the contact detection sensor 120 that is located on the outer surface of the contact region of the casing 113. In some embodiments, a material of the second protective layer 1233 may include silicone or other skin-friendly and flexible materials, such as a thermoplastic elastomer (TESiV) material, or the like.

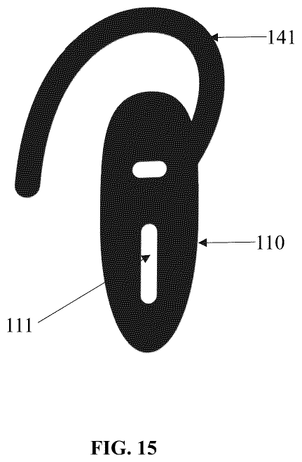

FIG. 15 is a schematic diagram illustrating an exemplary structure of an acoustic output device according to some embodiments of the present disclosure.

Referring to FIG. 15, in some embodiments, the acoustic output device 100 may include an ear-hook 141, one end of the ear-hook 141 is connected to the acoustic output unit 110, and when the acoustic output device 100 is used by a user, the ear-hook 141 suspends the acoustic output unit 110 near one ear of the user.

As shown in FIG. 15, in some embodiments, the acoustic output device 100 may include a monaural suspension earphone, which is a bone-conduction earphone, an air-conduction earphone, or a bone-air-conduction earphone. In some embodiments, the acoustic output device 100 may include various types, for example, electromagnetic (e.g., a moving coil type, a moving iron type, etc.), piezoelectric, inverse piezoelectric, electrostatic, or the like. The contact detection sensor 120 may be disposed at a contact region of a casing of the acoustic output unit 110 (e.g., the inner surface or the outer surface of the contact surface 111), and when the user wears the acoustic output device 100, the contact region may in contact with the human skin, and the contact detection sensor 120 may generate an electrical signal in response to the contact region is in contact with the human skin.

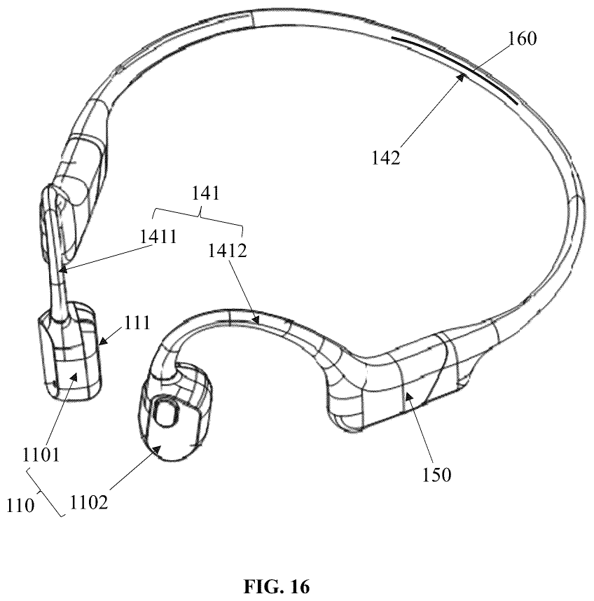

FIG. 16 is a schematic diagram illustrating an exemplary structure of an acoustic output device according to some other embodiments of the present disclosure.

Referring to FIG. 16, in some embodiments, the acoustic output device 100 may include a rear-hook earphone, the rear-hook earphone may include the ear-hook 141, the rear-hook 142, and the acoustic output unit 110. The ear-hook 141 may fit the shape of an ear auricle of a user to enable the acoustic output device 100 to suspend on the ear of the user. The rear-hook 142 may be placed behind the user's neck or head (e.g. when the user is wearing the acoustic output device 100 normally), the rear-hook 142 may be secured behind the user's head, and when the user is not using the acoustic output device 100 (e.g. when the acoustic output device 100 is in an abnormal wearing state), the user may hang the acoustic output device 100 around the neck, at which time the rear-hook 142 may be secured behind the user's neck. The ear-hook 141 and the rear-hook 142 cooperate to provide a clamping force that secures the acoustic output unit 110 to the user's head or ear, so that the acoustic output device 100 may hang stably on the user's ear and is not easy to fall.

In some embodiments, the acoustic output unit 110 includes a first acoustic output unit 1101 and a second acoustic output unit. The ear-hook 141 includes a first ear-hook 1411 and a second ear-hook 1412. The first ear-hook 1411 is connected to the first acoustic output unit 1101 and one end of the rear-hook 142, and the second ear-hook 1412 is connected to the second acoustic output unit 1102 and the other end of the rear-hook 142. The first ear-hook 1411 may be used to suspend the first acoustic output unit 1101 near one ear of a user, and the second ear-hook 1412 may be used to suspend the second acoustic output unit 1102 near the other ear of the user. Referring to FIG. 16, the casings of the first acoustic output unit 1101 and the second acoustic output unit 1102 may include a contact surface 111, which may be in contact with the human skin. In some embodiments, the contact detection sensor 120 is disposed on an inner surface or an outer surface of the contact surface 111.

Referring to FIG. 16, in some embodiments, an earphone compartment 150 is disposed between the ear-hook 141 and the rear-hook 142. In some embodiments, the earphone compartment 150 is used to enclose or accommodate one or more components of the acoustic output device 100 (e.g., a processor, a control circuit, a Bluetooth module, a battery, etc.).

As shown in FIG. 16, in some embodiments, a pressure sensor 160 based on a flexible cavity is disposed at a middle portion of the rear-hook 142. It will be appreciated that a structure illustrated in FIG. 16 is merely exemplary, and in some other embodiments, the pressure sensor 160 based on the flexible cavity is disposed at other locations that are capable of creating deformation or contact with the user during usage. For example, the pressure sensor 160 based on the flexible cavity is disposed on an inner side of the acoustic output unit 110 or an inner side of the earphone compartment 150. As another example, the pressure sensor 160 based on the flexible cavity is disposed at the ear-hook 141 (e.g., the first ear-hook 1411 and the second ear-hook 1412). In some embodiments, when an infrared sensor is used to control an operation state of the first piezoelectric element 1211, the infrared sensor is disposed on an inner side of the rear-hook 142, the inner side of the acoustic output unit 110, the inner side of the earphone compartment 150, or other locations where the human body may be detected. The inner side of the acoustic output unit 110 and the inner side of the earphone compartment 150 refer to sides that are close to the human skin during wearing.

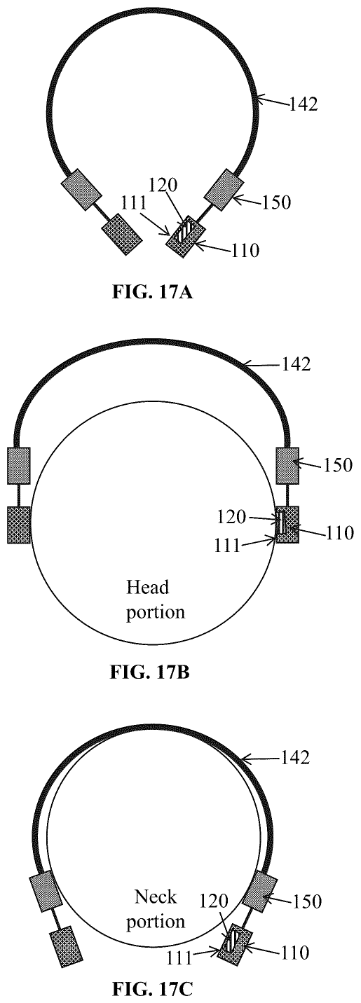

FIG. 17A is a schematic diagram illustrating an exemplary acoustic output device in a freely-placed state according to some embodiments of the present disclosure. FIG. 17B is a schematic diagram illustrating an exemplary acoustic output device in a normal wearing state according to some embodiments of the present disclosure. FIG. 17C is a schematic diagram illustrating an exemplary acoustic output device in an abnormal wearing state according to some embodiments of the present disclosure.

Referring to FIGS. 17A to 17C, in some embodiments, the contact detection sensor 120 is disposed at a contact region of a casing of at least one acoustic output unit 110 (e.g., an inner surface or an outer surface of the contact surface 111) for recognizing whether the acoustic output unit 110 is in contact with a user. As shown in FIG. 17A, when the contact detection sensor 120 detects a contact signal indicating that the acoustic output unit 110 is not in contact with the user, a first contact signal may be output. As shown in FIG. 17B and FIG. 17C, when a contact signal detected by the contact detection sensor 120 indicates that the acoustic output unit 110 is in contact with the user, a second contact signal may be output, and the first contact signal and the second contact signal may correspond to different signal parameters, which may include, but are not limited to, a resonant frequency, a capacitance, a resistance, a voltage, a current, or the like.

In some embodiments, the contact detection sensor 120 also includes an infrared sensor, and when the contact detection sensor 120 includes the infrared sensor, a distance between the acoustic output unit 110 and human skin is detected.

When the distance is greater than a preset distance threshold, it can be determined that the user is not in contact with the acoustic output unit 110, and when the distance is less than the preset distance threshold, it can be determined that the user is in contact with the acoustic output unit 110.

In some embodiments, the processor 130 may issue a corresponding control command in response to the contact signal detected by the contact detection sensor 120. For example, when the contact signal detected by the contact detection sensor 120 indicates that the acoustic output device 100 is in the normal wearing state (shown in FIG. 17B), the processor 130 may control the acoustic output device 100 to be in a wake-up state to automatically connect to Bluetooth or play music. In contrast, when the contact signal detected by the contact detection sensor 120 indicates that the acoustic output device 100 is in the abnormal wearing state (shown in FIG. 17C) or in the freely-placed state (shown in FIG. 17A), the processor 130 may control the acoustic output device 100 to automatically stop playing music or to disconnect from the Bluetooth, and cause the acoustic output to enter a standby mode after the state has lasted for a period (e.g., 10 seconds, 15 seconds, etc.)

Beneficial effects that may be brought by the embodiments of the present include, but are not limited to: (1) by setting the contact detection sensor on the inner surface of the contact region of the casing, it is conducive to wired connection and eliminate the need for punching operation, preventing damage to the integrated design of the casing, and thus improving the sealing performance and waterproof performance of the acoustic output device to a certain degree; (2) the wearing detection function is realized by using the resistive pressure sensor, and the resistive pressure sensor is directly affixed to the inner surface of the contact region of the casing of the acoustic output device, which can effectively shield the influence of external environments, such as water and perspiration, and thereby improving the accuracy of recognition to a certain extent; (3) by setting the contact detection sensor on the outer surface of the contact region of the casing, and then through wirelessly coupling between the contact detection sensor and the coupling circuit disposed on the inner surface of the contact region, the electrical signal generated by the contact detection sensor can be transmitted to the processing chip located inside the casing, so the sensitivity of the contact detection sensor can be improved while ensuring the sealing performance and waterproof performance of the acoustic output device; (4) by combining the capacitive electrode and the resistive pressure sensor to jointly detect the current usage state of the acoustic output device, it is possible to avoid misrecognition due to collision and extrusion of the acoustic output device with other objects when the resistive pressure sensor is used alone, and it is also possible to avoid misrecognition due to interference from the external environment, such as water, sweat, etc., when the capacitive electrode is used alone, so that most of the interferences can be eliminated, henceforth greatly improving the recognition accuracy of the usage state of the acoustic output device.

It should be noted that the beneficial effects that may be produced by different embodiments are different, and the beneficial effects that may be produced in different embodiments may be any one or a combination of any one or a combination of any of the foregoing, or any other beneficial effect that may be obtained.

The basic concepts have been described above, and it is apparent to those skilled in the art that the foregoing detailed disclosure serves only as an example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

1. An acoustic output device, comprising:
an acoustic output unit including a vibration unit and a casing, the casing at least including a contact region which is in contact with the face of a user, wherein the vibration unit is elastically connected with the casing through a vibration transmission sheet;
a contact detection sensor located at the contact region, wherein, along a vibration direction of the vibration unit, a spacing between the contact detection sensor and the vibration transmission sheet is greater than 300 um; and
a processor configured to determine whether the user wears the acoustic output device based on an electrical signal generated when the contact detection sensor is in contact with the face of the user.

2. The acoustic output device of claim 1, wherein the contact detection sensor includes an inductive element, a piezoelectric element, and a processing chip, the piezoelectric element is connected with an inner surface of the contact region, the piezoelectric element generates vibration based on a preset voltage, the inductive element is connected in parallel with the piezoelectric element to form a loop, and the processing chip is configured to read out a resonant frequency of the loop.

3. The acoustic output device of claim 2, wherein the contact detection sensor includes a capacitive element, and the capacitive element is connected in parallel with the piezoelectric element.

4. The acoustic output device of claim 1, wherein the contact detection sensor includes a first piezoelectric element and a receiving element that are stacked, a side of the first piezoelectric element that is back away from the receiving element is connected with an inner surface of the contact region, the first piezoelectric element generates vibration based on a preset voltage, and a vibration state of the first piezoelectric element changes when the user is in contact with the contact region.

5. (canceled)

6. The acoustic output device of claim 4, wherein the receiving element includes an air-conduction microphone or a second piezoelectric element.

7. The acoustic output device of claim 4, wherein the contact detection sensor further includes a substrate, and the first piezoelectric element and the receiving element are stacked with the substrate.

8. The acoustic output device of claim 1, wherein the contact detection sensor includes a substrate, a first circuit board, and a resistive thin film layer that are stacked, the substrate is connected with an inner surface of the contact region, the contact detection sensor deforms in response to deformation of an inner surface and converts the deformation into an electrical signal.

9. The acoustic output device of claim 8, wherein the resistive thin film layer includes at least two sensitive thin film resistors and at least two fixed thin film resistors, and the at least two sensitive thin film resistors are electrically connected with the at least two fixed thin film resistors to form a bridge circuit.

10. The acoustic output device of claim 9, wherein a plurality of grooves are provided on a surface of the substrate that is connected with the first circuit board, the plurality of grooves including at least two grooves that face the at least two sensitive thin film resistors, respectively.

11. The acoustic output device of claim 8, wherein the contact detection sensor includes a second circuit board, and a side of the second circuit board is connected with one side of the substrate that is back away from the first circuit board, and another side of the second circuit board is provided with a capacitive electrode.

12. (canceled)

13. The acoustic output device of claim 1, wherein the vibration unit is elastically connected with the casing through a vibration transmission sheet, the vibration transmission sheet includes a hollow region, and a projection of the contact detection sensor along a vibration direction of the vibration unit is located within the hollow region.

14. The acoustic output device of claim 1, further comprising a coupling circuit, wherein
the contact detection sensor is disposed on an outer surface of the contact region, the coupling circuit is disposed on an inner surface of the contact region, and the coupling circuit is wirelessly coupled with the contact detection sensor.

15. The acoustic output device of claim 14, wherein the coupling circuit includes a first inductive element, a first capacitive element, and a processing chip, and the contact detection sensor includes a second capacitive element and a second inductive element, the first inductive element is connected in parallel with the first capacitive element to form a first circuit, the second inductive element is connected in parallel with the second capacitive element to form a second circuit, and the processing chip is configured to read out a resonant frequency after the first circuit is coupled with the second circuit.

16. The acoustic output device of claim 15, wherein the coupling circuit includes a third circuit board, one side of the third circuit board is connected with the inner surface of the contact region, and the first inductive element, the first capacitive element, and the processing chip are located on one side of the third circuit board that is back away from the contact region.

17. The acoustic output device of claim 15, wherein the second capacitive element and the second inductive element are disposed on the outer surface of the contact region, and the second inductive element is disposed directly opposite to the first inductive element.

18. The acoustic output device of claim 17, wherein the second capacitive element is a pressure-sensitive capacitor, and a capacitance value of the second capacitive element changes in response to a change in a pressure applied on the second capacitive element.

19. The acoustic output device of claim 17, wherein the contact detection sensor includes a fourth circuit board, one side of the fourth circuit board is connected with the outer surface of the contact region, and the second capacitive element and the second inductive element are disposed on one side of the fourth circuit board that is back away from the contact region.

20. The acoustic output device of claim 14, wherein a protective layer is disposed on the outer surface of the contact region, and the protective layer covers the contact detection sensor.

21-23. (canceled)

24. The acoustic output device of claim 4, wherein the first piezoelectric element and the receiving element form an ultrasound sensor.

25. The acoustic output device of claim 1, wherein the contact detection sensor includes a capacitive electrode and a resistive thin film layer, and in response to a determination that a change in a capacitance value of the capacitive electrode reaches a first threshold value and a change in a resistance value of the resistive thin film layer reaches a second threshold value, simultaneously, the processor determines that the acoustic output device is in a normal wearing state.
